(19) United States
(12) Patent Application Publication
(10) Pub. No.: US 2005/0094826 A1
(43) Pub. Date: May 5, 2005

(54) Processing equipment of the sound of a car

(75) Inventor: Motonobu Morishita, Hamamatsu-city (JP)

Correspondence Address: FOLEY & LARDNER, 2029 CENTURY PARK EAST, SUITE 3500, LOS ANGELES, CA, 90067, US

(73) Assignee: ROLAND CORPORATION

(21) Appl. No.: 10/975,608

(22) Filed: Oct. 28, 2004

(30) Foreign Application Priority Data
Oct. 31, 2003 (JP) 2003-372514

(51) Int. Cl. H04R 29/00; H04B 1/00

(52) U.S. Cl. 381/86; 381/56

(57) ABSTRACT

An automobile sound processing system has a detection device with which the automobile sound that is generated by the motive power section of an automobile is detected. The system also includes an input with which the automobile sound that has been detected by the detection means is input. The system further includes an effect imparting device with which an effect is imparted to the automobile sound that is input in conformance with the operating state of the motive power section of the automobile.

### CROSS-REFERENCE TO RELATED PATENT APPLICATIONS

Japan Priority Application 2003-372514, filed Oct. 31, 2003 including the specification, drawings, claims, and abstract, is incorporated herein by reference in its entirety.

### BACKGROUND OF THE INVENTION

1. Field of the Invention

The present invention relates to an automobile sound processing system and, in particular, it relates to an automobile sound processing system in which the automobile sound that is produced by the engine and the transmission of the automobile is processed and generated inside the automobile passenger compartment.

2. Related Art

For some time, in the field of engine sound processing systems for automobiles, systems in which the engine sounds (including the exhaust sounds) of various types of automobiles are stored in a storage means and are reproduced in conformance with the running state of the automobile have been known. Such a system is disclosed in Japanese Laid-Open Patent Application Publication (Kokai) Number 2000-10576. Systems in which an exhaust sound is generated in conformance with a vehicle type and a muffler type that are selected by a user have also been known. In addition, as has been disclosed in Japanese Laid-Open Patent Application Publication (Kokai) Number Hei 11-219192, a system where a pseudo engine sound is generated inside a passenger compartment, in which an alternator sound that is extracted from a battery is transformed, is known.

However, when the engine sound (including the exhaust sound) that is stored in the storage means cited in Japanese Laid-Open Patent Application Publication (Kokai) Number 2000-10576 is reproduced in conformance with the running state of the automobile, a delay is produced in the change of the engine sound when compared to the actual running state of the automobile. Also, a sound that is different from the running state of the automobile is generated, and there has been a feeling of incompatibility.

In addition, the engine sound of the automobile that is cited in Japanese Laid-Open Patent Application Publication (Kokai) Number Hei 11-219192 is a pseudo engine sound that is generated by the transformation of the alternator noise and, since the change in the sound is also different from the change in the running state of the automobile, there is, of course, still a feeling of incompatibility.

### SUMMARY OF THE DISCLOSURE

The preferred embodiment is one that was done in order to solve the problems discussed above and has as its object the provision of an automobile sound processing system in which processing can be carried out, such as imparting an effect to an automobile sound that is produced by a motive power section of an automobile and generating the resulting sound inside the passenger compartment of the automobile.

In order to achieve this object, the automobile sound processing system of an embodiment is furnished with a detection means with which an automobile sound that is generated by a motive power section of an automobile is detected, an input means with which the automobile sound that has been detected by the detection means is input, and an effect imparting means with which an effect is imparted to the automobile sound that is input in the input means in conformance with the operating state of the motive power section of the automobile.

By means of the automobile sound processing system of such an embodiment, an effect is imparted to the sounds that are produced by the motive power section of the automobile. The sounds are obtained from the engine, the muffler, the transmission, and the like. The effect is imparted in conformance with the state of the motive power section of the automobile, such as the RPM (revolution per minute) or the load of the engine and the like.

The automobile sound processing system in accordance with another embodiment is one where the effect imparting means is one in which the frequency characteristics of the automobile sound that is input in the input means are changed.

The automobile sound processing system in accordance with another embodiment is one where the previously mentioned effect imparting means is one in which the characteristics of a filter through which the automobile sound is passed are changed in conformance with the level of the automobile sound that is input in the input means.

The automobile sound processing system in accordance with another embodiment is one where the effect imparting means is one in which the characteristics of a filter through which the automobile sound that is input in the input means is passed are changed in conformance with the RPM of the engine of the automobile.

The automobile sound processing system in accordance with another embodiment is one where the effect imparting means is one in which the characteristics of a filter through which the automobile sound that is input in the input means is passed are changed in conformance with automobile engine load.

The automobile sound processing system in accordance with another embodiment is furnished with a vehicle type selection means, and the effect imparting means is one in which the conditions of the effect that is imparted to the automobile sound are further changed in conformance with the vehicle type that has been selected by the vehicle type selection means.

The automobile sound processing system in accordance with another embodiment is furnished with an operator that sets a control value, and the effect imparting means is one in which the conditions of the effect that is imparted to the automobile sound are further changed in conformance with the control value that has been set by the operator.

The automobile sound processing system in accordance with another embodiment is one in which the effect imparting means is configured by means of a DSP.

The automobile sound processing system in accordance with another embodiment is one where the vehicle type selection means is one that is configured by means of a touch panel, and by pointing at a touch position of a plurality of display positions for automobile types that are displayed on the touch panel, the vehicle type that is displayed at that position is selected.

The automobile sound processing system in accordance with another embodiment is one in which the proportion of the change in the gain of a filter that corresponds to the RPM is controlled in conformance with a control value that is set by means of the operator.

The automobile sound processing system in accordance with another embodiment is one in which the effect imparting means is a bandpass filter through which the automobile sound that is input in the input means is passed, and the proportion of the change in the center frequency of the bandpass filter that corresponds to the RPM is controlled in conformance with a control value that is set by means of the operator.

The automobile sound processing system in accordance with another embodiment is one in which the effect imparting means is a shelving filter through which the automobile sound that is input in the input means is passed, and the proportion of the change in the gain of the shelving filter that corresponds to the envelope level of the automobile sound is controlled in conformance with a control value that is set by means of the operator.

### BRIEF DESCRIPTION OF THE DRAWINGS

FIG. 1 is a block diagram that shows the electrical configuration of the automobile sound processing system of an embodiment;

FIG. 2 is a drawing that shows the operating panel;

FIG. 3 is a drawing that shows the processing that is executed by the DSP;

FIG. 4 is a drawing that shows the situation in which the frequency characteristics of the engine sound are changed in conformance with the envelope level of the engine sound;

FIG. 5 is a drawing that shows the cutoff frequency and the gain of the HSHV that are set in conformance with the type of preset;

FIG. 6 is a drawing that shows the situation in which the parameters of the HSHV are changed in conformance with the envelope level of the engine sound;

FIG. 7 is a drawing that shows the situation in which the frequency characteristics of the engine sound are changed in conformance with the RPM of the engine;

FIG. 8 is a drawing that shows the settings of the center frequency and the gain of a bandpass filter in conformance with the type of preset;

FIG. 9 is a drawing that shows the situation in which the parameters of the bandpass filter are changed in conformance with the RPM of the engine;

FIG. 10 is a flowchart that shows the processing that is executed by the CPU in accordance with a program;

FIG. 11 is a drawing that shows schematically the first method that is executed in the DSP in which the frequency characteristics of the engine sound are changed in conformance with the changes in the load and the RPM of the engine; and

FIG. 12 is a drawing that shows schematically the second method that is executed in the DSP in which the frequency characteristics of the engine sound are changed in conformance with the changes in the load and the RPM of the engine.

### DETAILED DESCRIPTION OF THE PREFERRED EMBODIMENTS

In accordance with the automobile sound processing system of a preferred embodiment, since the system is furnished with a detection means in which the automobile sound that is produced by the motive power section of the automobile is detected, an input means in which the automobile sound that has been detected is input, and an effect imparting means in which an effect is imparted to the sound that is input in the input means in conformance with the operating state of the motive force section of the automobile, it is possible to impart a sound effect to an automobile sound, such as the engine sound and the like, that matches and is in agreement with the operating state of the engine. Because of this, there is the advantageous result that it is possible to enjoy a sound that is made different from the original sound produced by the automobile. Also, compared to a system in which a waveform that has been stored in a storage means is read out, an automobile sound that matches and is more in agreement with the actual operating state of the motive power section of the automobile and has a high degree of presence, can be produced.

An ideal effect to be imparted by the effect imparting means is to change the frequency characteristics of the automobile sound. There is the advantageous result that, by this means, it is possible to process and generate an automobile sound that has characteristics that are different from the automobile sound and which are in conformance with the vehicle type and operator preferences.

In addition, the operating state of the motive power section of the automobile can be determined from the envelope level of the engine sound, the engine load, or the engine RPM. There is the advantageous result that, by changing the characteristics of a filter in conformance with these conditions, it is possible to better change the characterization of the automobile sound or to change the automobile sound that is emphasized.

In addition, since a means is provided with which the method is one of changing the frequency characteristics in conformance with the motive force section or the running state of the engine and the like, there is the advantageous result that it is possible to modify the automobile sound in accordance with the preferences of the user.

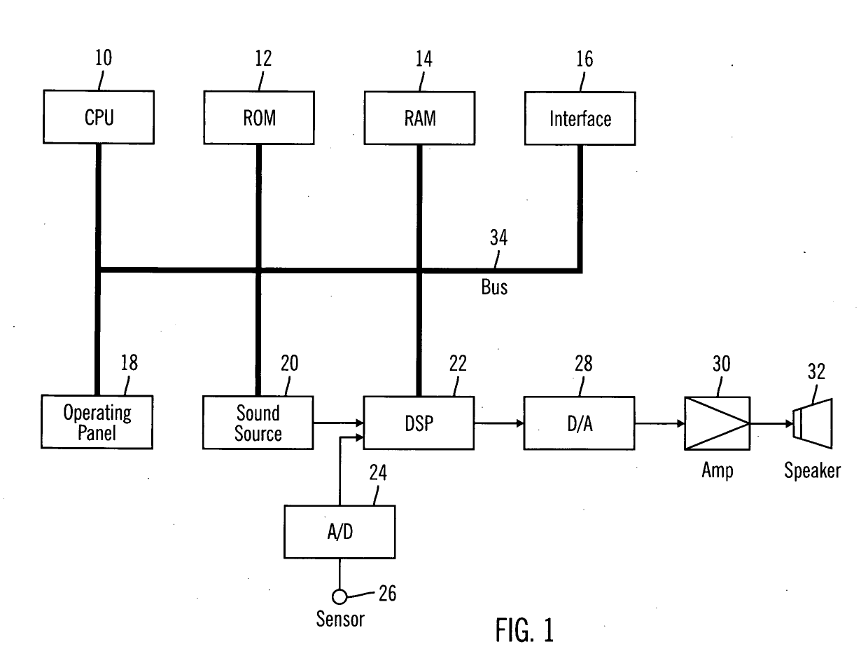

An explanation will be given below regarding preferred embodiments of the present invention while referring to the attached drawings. FIG. 1 is a block diagram that shows the electrical configuration of the automobile sound processing system in accordance with the present invention. In the drawing, the CPU 10, the ROM 12, the RAM 14, the interface 16 for the internal automobile LAN (local area network) that connects with other CPUs that are installed in each area of the automobile and possess various kinds of information, the operating panel 18 that is furnished with operators that are operated by the user and the like, the sound source 20 that generates specified sounds, and the DSP that carries out the processing for the imparting of the effects to the automobile sounds and the like are connected by the bus 34.

The CPU 10 is a central processing unit and each of the various types of control programs that are executed by the CPU 10 as well as the fixed value data that are referred to at the time that the programs are executed are stored in the ROM 12. The programs that are executed by the DSP 22, which will be discussed later, and each of the various kinds of tables such as the tables that are referred to by the DSP 22 at the time that the effect is imparted are stored in the ROM 12.

The RAM 14 has the working area in the which each of the various kinds of register groups that are required when the control programs are executed by the CPU have been set and the temporary working area in which the data are stored temporarily during processing and the like and is a rewritable memory that can be accessed randomly.

The interface 16 is the interface for the internal automobile LAN, and it is possible to obtain information such as the automobile speed that is displayed by the speedometer, the RPM of the engine that is displayed by the tachometer, the gear ratio at which the transmission is currently set, and the like via this interface.

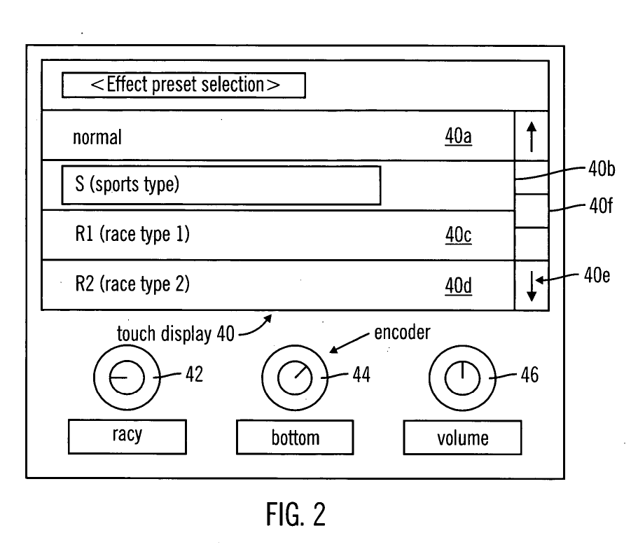

The operating panel 18, as is shown in FIG. 2, is the operator group with which each of the various kinds of parameters is set and has operators for adjusting the volume and the tone, and the effect selection switch.

The sound source 20 reads out the waveforms that have been stored in the waveform memory with which the sound source 20 has been furnished and outputs the waveforms to the DSP 22. With this system, together with imparting an effect to the automobile sound, it is possible to add the sounds that are stored in the sound source 20 and increase the variations of the automobile sounds.

The DSP 22 is a digital signal processing circuit that carries out processing such as converting the electrical signals that are obtained from the sensors 26 that are attached to the various parts of the engine, the muffler, the transmission, and the like into a digital signal by means of an A/D converter, and imparting an effect to the digital signal and the like. The speakers 32 are arranged in a plurality of locations in front of and behind the seats inside the automobile.

FIG. 2 is a drawing that shows the operating panel 18 in detail. On the touch display 40, the LCD display screen is furnished with pressure sensors and it is possible for the operation to be carried out in which, when a location has been pressed by the user, the selection and the like are made in conformance with the contents that are displayed at that location. A screen in which various kinds of selections are made of the effects that are preset is shown as the screen of this drawing.

The presets for the four types of effects of normal 40a, S (sports type) 40b, R1 (race type 1) 40c, and R2 (race type 2) 40d are shown; and when the display region for any of these is pressed, the preset that is displayed in that region is selected. In the drawing, an example is shown in which the S (sports type) 40b is an inverted display and is currently selected. The normal 40a is a preset in which no effect at all is applied; and in those cases where this preset has been selected, the automobile sounds that have been detected by the sensor 26 are amplified by the amp 30 as they are unchanged and emitted from the speakers 32.

The region 40e, in which the vertical arrows are shown, is an operating region with which the display contents are scrolled and in those cases where an effect other than the type of effect that is currently displayed is set or in those cases where other parameters are set, and the like, it is possible to scroll upward or downward by pressing on the arrows.

The racy 42, bottom 44, and volume 46, which are the encoders, are rotating knobs that set each of the parameters. The volume 46 adjusts the volume of the output from the speakers 32. The details regarding the racy 42 and the bottom 44 will be discussed later.

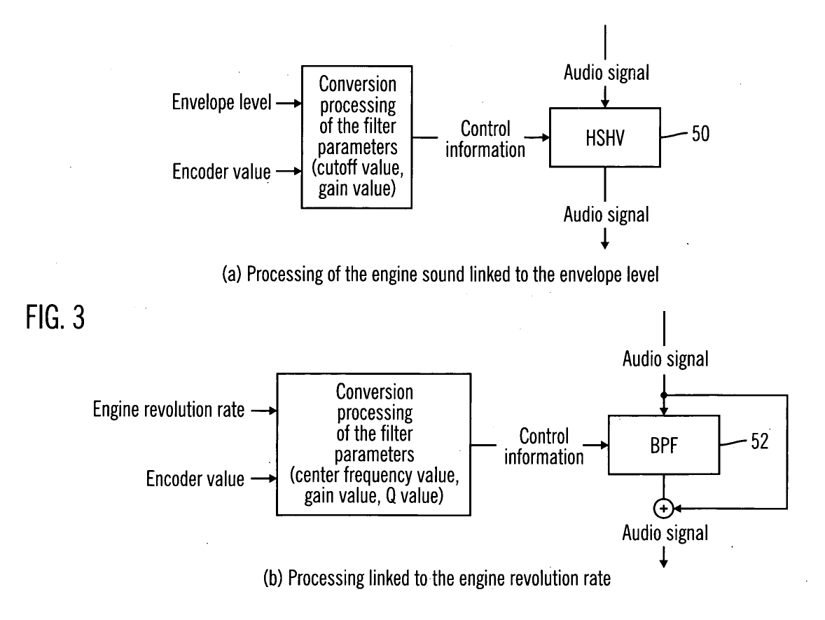

FIG. 3 is a block diagram for the simplified explanation of the processing that is carried out by the DSP 22. The automobile sounds are many types of sounds, such as the sounds that are produced by the engine, the muffler, and the transmission, together with the running of the automobile. These sounds change in many ways in conformance with the running state, and the levels and frequency characteristics of the automobile sounds make changes that are extraordinarily complicated. A large number of filters such as a low pass filter, a bandpass filter, a high pass filter, a comb filter, and the like are required in order to change the frequency characteristics of these sounds in conformance with the vehicle type, and it is necessary to change the characteristics of each of these filters to match the state of the motive force section and the running state.

In this preferred embodiment, in order to make understanding easier, the explanation will be given with an engine sound that is produced by the engine itself as an example. In addition, it has been decided to give an explanation regarding an example in which the characteristics of the two filters that are the most distinctive among these filters are changed by a single parameter each. In the explanation given below, the envelope level of the engine sound and the engine RPM exemplify the parameters, but the engine load may also be substituted for either of the parameters. Incidentally, the engine load can be obtained from the automobile speed, the acceleration, the transmission gear ratio, and the like.

FIG. 3(a) is a drawing that shows the signal processing section in which the frequency characteristics of the engine sound that is input have been set so as to be changed linked to the envelope level of the engine sound. The volume and tone of the engine sound are both changed in those cases where the accelerator is stepped on and the automobile accelerates and when engine braking is applied going down a slope. The method of the change is different depending on whether the engine is one such as a sports type or a racing type and, when these states are simulated by the signal processing section, it is possible to make it as if the automobile were a normal vehicle or make the conversion as if the automobile were a sports type or a racing type.

The filter comprises the HSHV (high shelving filter) 50. The cutoff frequency and the gain of the filter 50 change in conformance with the envelope level (the volume of the engine sound) and the control value that is set by means of the encoder.

FIG. 3(b) is a drawing that shows the signal processing section in which the frequency characteristics of the engine sound that is input have been set so as to be changed linked to the engine RPM. The volume and tone of the engine sound of the automobile are changed in conformance with the engine RPM. The method of the change is different depending on whether the engine is one such as a sports type or a racing type and, when these states are simulated by the signal processing section, it is possible to make it as if the automobile were a normal vehicle or to make the conversion as if the automobile were a sports type or a racing type. The filter comprises the BPF (bandpass filter) 52. The center frequency, the gain, and the Q of the bandpass filter 52 change in conformance with the engine RPM and the control value that is set by means of the encoder.

The engine RPM may be obtained from the information that is displayed by the tachometer, or the firing cycle of the spark plugs, or it may be set up such that the pitch or frequency characteristics of the engine sound are detected and the RPM obtained from that information. Incidentally, the HSHV 50 that has been shown in FIG. 3(a) and the bandpass filter 52 that has been shown in FIG. 3(b) described above are arranged in series and, depending on the context, either one is fine.

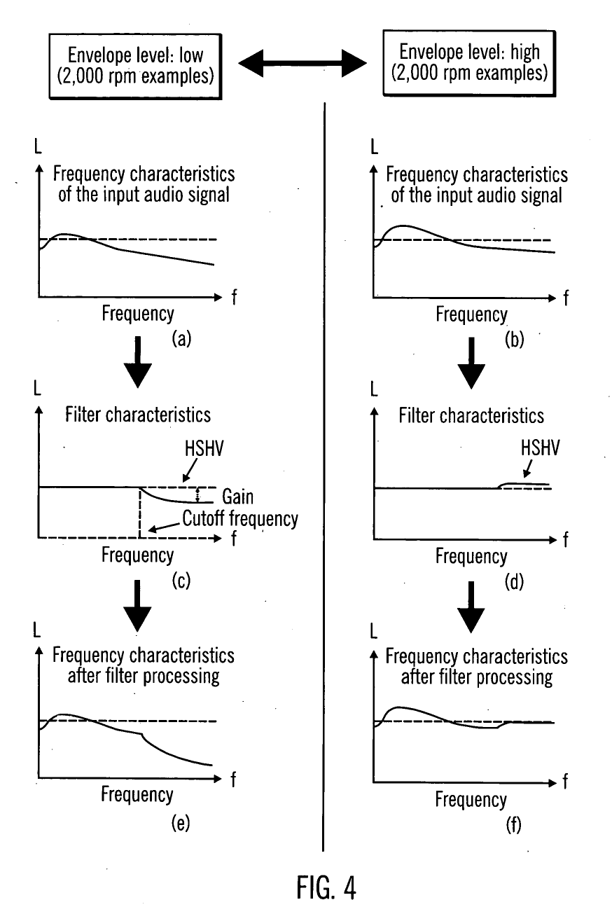

FIG. 4 shows the situation in which the frequency characteristics of the engine sound are changed by changing the characteristics of the filter in conformance with the envelope level of the engine sound and an explanation will be given here regarding the case in which a sensor is attached to the engine of a so-called normal vehicle and the preset S (sports type) has been selected and the RPM is 2,000 rpm.

In FIG. 4, (a) shows the frequency characteristics of the engine sound when the envelope level of the engine of a normal vehicle is low. This automobile has characteristics with a peak in the low region and that attenuate with a gentle slope toward the high region. (b) shows the frequency characteristics in the case where the RPM for a normal vehicle is the same 2,000 rpm and the envelope level is high, and the level is raised across the entire region and particularly augmented in the low region compared to the case in which the envelope level is low.

With S (a sports type), which is the preset that is selected, when the envelope level is low, the filter characteristics are made such as those shown in (c), in other words, characteristics in which the level of the high region is lowered. And, when the envelope level of the engine sound is high, the filter characteristics are made ones in which the high region is brought up a bit as is shown in (d).

(e) shows the frequency characteristics of the engine sound that is obtained when the engine sound that is shown in (a) is processed using a filter having the characteristics shown in (c) and the high region of the original automobile sound is suppressed. (f) shows the frequency characteristics of the engine sound that is obtained when the engine sound that is shown in (b) is processed using a filter having the characteristics shown in (d) and the high region of the original automobile sound is brought up. By changing the filter characteristics in conformance with the envelope level in this manner, it is possible to imitate the behavior of the engine sound of a sports type.

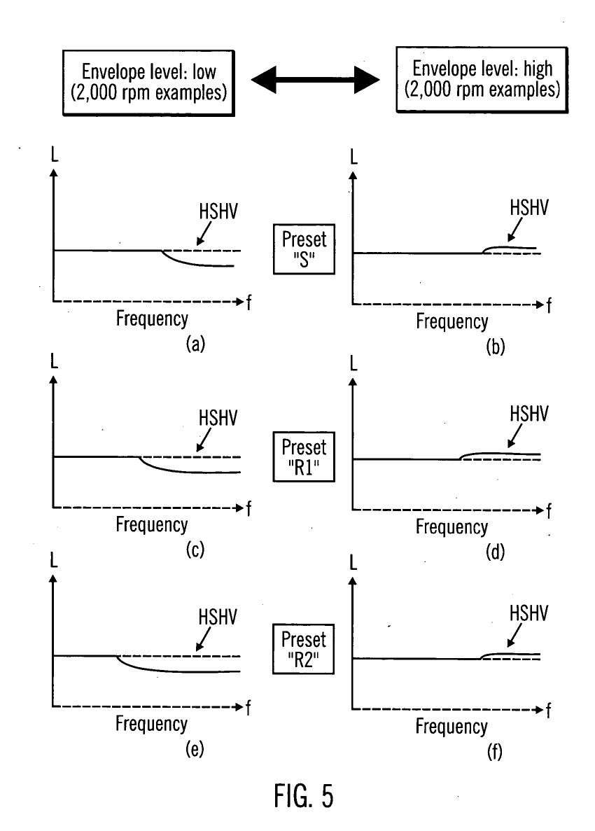

FIG. 5 shows the cutoff frequency and the gain of the HSHV 50 that is set in conformance with the type of preset and, when the preset is S (a sports type) in those cases where, in the same manner, the engine RPM is 2,000 rpm, the filter characteristics when the envelope level of the engine sound is low are shown in (a) and the filter characteristics when the envelope level of the engine sound is high are shown in (b) (the same as in FIGS. 4(c) and (d)).

The filter characteristics when the envelope level of the engine sound is low are shown in (c), and the filter characteristics when the envelope level of the engine sound is high are shown in (d) for when the preset is R1 (a race type 1). The cutoff frequency of the HSHV 50 in both the case where the envelope level of the engine sound is low and the case where the level is high is set low compared to S (a sports type). The filter characteristics when the envelope level of the engine sound is low are shown in (e) and the filter characteristics when the envelope level of the engine sound is high are shown in (f) for when the preset is R2 (a race type 2). In the case where the envelope level of the engine sound is low, the cutoff frequency of the HSHV 50 is set even lower compared to that of R1 (a race type 1) and, in the case where the envelope level of the engine sound is high, the cutoff frequency of the HSHV 50 is set high.

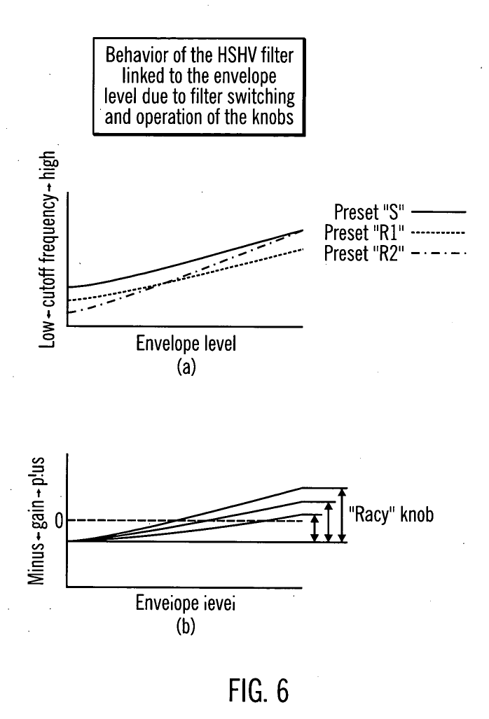

FIG. 6 is a drawing that shows the situation in which the parameters of the HSHV are changed in conformance with the envelope level of the engine sound. In FIG. 6(a), the change curves in which the cutoff frequency of the HSHV 50 is changed in accordance with the envelope level of the engine sound are shown for each of the presets. The horizontal axis is the envelope level, the vertical axis is the cutoff frequency, the preset S is shown as a solid line in the graph, the preset R1 as a broken line, and the preset R2 as a single dotted broken line. For all of them, the cutoff frequency is set to become higher as the envelope level increases, but the slope and the size are different depending on the preset.

FIG. 6(b) shows the change curves for the change in the gain of the HSHV 50 in accordance with the envelope level of the engine sound for each setting of the racy 42, which is one of the knobs of the encoder shown in FIG. 2. In the graph, the horizontal axis is the envelope level and the vertical axis is the gain of the HSHV 50. As the envelope level increases, the gain changes from a negative specified value toward the positive direction and the slope increases as the control value that is set by the racy 42 becomes greater.

Incidentally, the envelope level can be obtained by means of such methods as the rectification of the engine sounds that are input and the integration of the wave values that have been integrated.

Next, an explanation will be given regarding the processing in which the frequency characteristics of the automobile sounds are changed linked to the engine RPM.

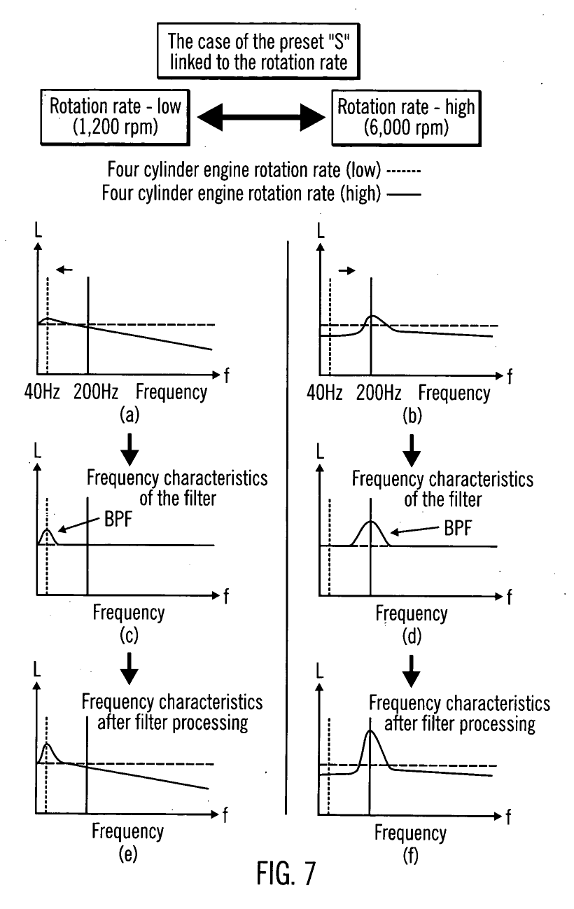

FIG. 7 shows the situation in which the frequency characteristics of the engine sounds are changed by changing the characteristics of the filter in conformance with the engine RPM, and an explanation will be given here regarding the case in which a sensor is attached to the engine of a normal vehicle and S (a sports type) is selected as the preset.

FIG. 7(a) shows the frequency characteristics of the engine sound of a normal vehicle when the RPM of the engine is 1,200 rpm. There is a peak in the vicinity of 40 Hz and a gradual attenuation heading toward the high region. FIG. 7(b) shows the frequency characteristics of the engine sound for the same normal vehicle when the RPM of the engine is 6,000 rpm. There is a peak in the vicinity of 200 Hz and a gradual attenuation moving toward the high region. Incidentally, with regard to 1,200 rpm, when this RPM only is converted as it is into a frequency, it is 20 Hz and, in a four cycle engine, since one explosion occurs in two revolutions, the explosion cycle in the case of one cylinder is 10 Hz. In the case of four cylinders, the interval between explosions for the four cylinders differs depending on the vehicle type, but the explosions have been made to be at roughly equal intervals here and the peak of the frequency characteristics is at about 40 Hz. In the same manner, the peak for the frequency characteristics in the case where the RPM is 6,000 rpm is 200 Hz.

For the filter characteristics, with S (a sports type) as the preset that is selected, when the engine RPM is low, as is shown in (c), the center frequency of the bandpass filter is made about 40 Hz, which is the frequency that becomes the peak of the frequency characteristics of the engine sound. When the engine RPM is high, as is shown in (d), the center frequency of the bandpass filter is made about 200 Hz, which is the frequency that becomes the peak of the frequency characteristics of the engine sound and, together with this, the gain of the bandpass filter is increased.

(e) shows the frequency characteristics of the engine sound in the case in which the engine RPM is low, and the processing of the engine sound that is shown in (a) has been done with a bandpass filter that has the characteristics shown in (c) and the frequency that corresponds to the RPM of the original engine sound is slightly raised.

(f) shows the frequency characteristics of the engine sound in the case in which the engine RPM is low and the processing of the engine sound that is shown in (b) has been done with a bandpass filter that has the characteristics shown in (d) and the level of the frequency that corresponds to the RPM of the original engine sound is raised higher.

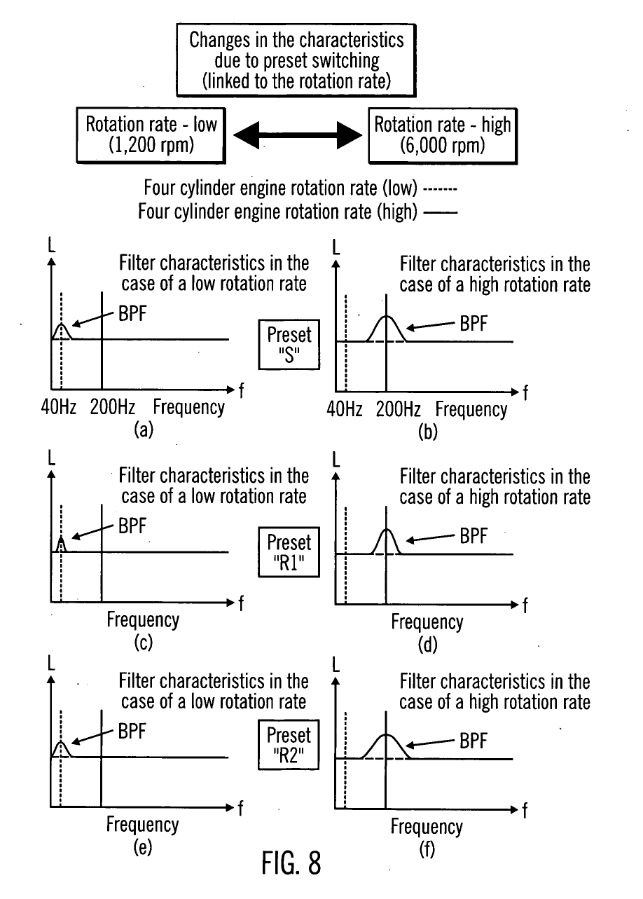

FIG. 8 shows the center frequency and the gain of the bandpass filter 52 that is set in conformance with the type of preset. When the preset is S (a sports type), the filter characteristics when the engine RPM is 1,200 rpm are shown in (a), and the filter characteristics when the engine RPM is 6,000 rpm are shown in (b) (the same as in FIGS. 7(c) and (d)).

When the preset is R1 (a race type 1), the filter characteristics when the engine RPM is 1,200 rpm are shown in (c), and the filter characteristics when the engine RPM is 6,000 rpm are shown in (d). Compared to S (a sports type), the center frequencies of the bandpass filter 52 are the same in the case where the engine RPM is low and the case where the RPM is high but the bandwidth is set narrow.

When the preset is R2 (a race type 2), the filter characteristics when the engine RPM is 1,200 rpm are shown in (e), and the filter characteristics when the engine RPM is 6,000 rpm are shown in (f). Compared to RI (a race type 1), the center frequency of the bandpass filter 52 is the same but bandwidth is set wide.

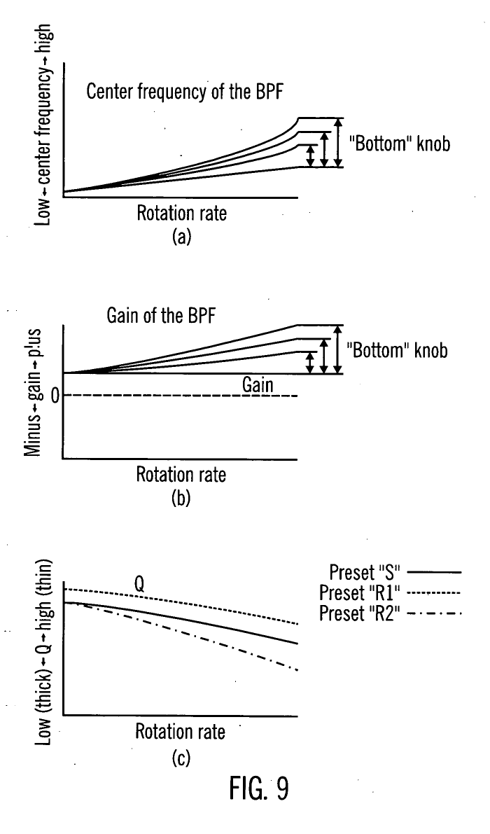

FIG. 9 is a drawing that shows the situation in which the parameters of a bandpass filter are changed in conformance with the RPM of the engine. FIG. 9(a) shows the change curves in which the center frequency of the bandpass filter 52 that has been changed in accordance with the RPM of the engine has been altered for each control value that is set by the bottom 44, which is an encoder. The horizontal axis is the RPM of the engine, the vertical axis is the center frequency of the bandpass filter 52, and this is a graph that shows when the bottom 44 setting is low, medium, and high. For all of them, center frequency of a bandpass filter 52 is set highly as the RPM of the engine becomes higher, but the tendency for the right side to rise is set larger as the control value that is set by the bottom 44 increases. Incidentally, since the frequency (Hz) that is the peak of the frequency characteristics of the engine sound is derived from a calculation by means of Formula 1 from the RPM and number of cylinders of a four cycle engine, it may be set up such that the center frequency of the bandpass filter 52 is set by applying a coefficient in conformance with the control value that is set by the bottom 44 to the frequency.

In Formula 1, the reason for the division by 60 is that the Hertz (Hz), which is the frequency unit is the value per one second, so that the RPM is a value per one minute. And the reason for the division by 2 is that, in the case of a four cycle engine, the explosions are done once for each two rotations of the rotation of the engine.

$$Frequency ( Hz ) = \frac{Revolutions per Minute \times number of cylinders}{60 \times 2}$$

FIG. 9(b) shows the change curves in which the gain of the bandpass filter 52 has been changed in the same manner in accordance with the RPM of the engine for each setting of the bottom 44, which is an encoder. The horizontal axis is the RPM of the engine, the vertical axis is the gain of the bandpass filter 52, and this is a graph that shows when the control values that are set by the bottom 44 are low, medium, and high. For all of them, the gain is set to vary from a specified value to the positive direction as the RPM of the engine becomes higher, but the tendency for the right side to rise is set larger as the control value that is set by the bottom 44 increases.

FIG. 9(c) shows, in the same manner, the change curves in which the Q of the bandpass filter 52 has been changed in accordance with the RPM of the engine. The horizontal axis is the engine RPM, the vertical axis is the Q of the bandpass filter, and the graph shows respectively a solid line in the case of the preset S, a broken line in the case of the preset R1, and a single dotted broken line in the case of the preset R2. For all of them, the setting is such that the Q becomes smaller as the RPM of the engine increases.

As has been elucidated above, an explanation has been given of the situations in which the frequency characteristics for the engine sound are changed in conformance with the changes in the envelope level and the RPM, as well as the alteration of the change situation by the presets and the settings of the encoder.

Next, an explanation will be given regarding the processing that is carried out by the CPU 10 and the DSP 22.

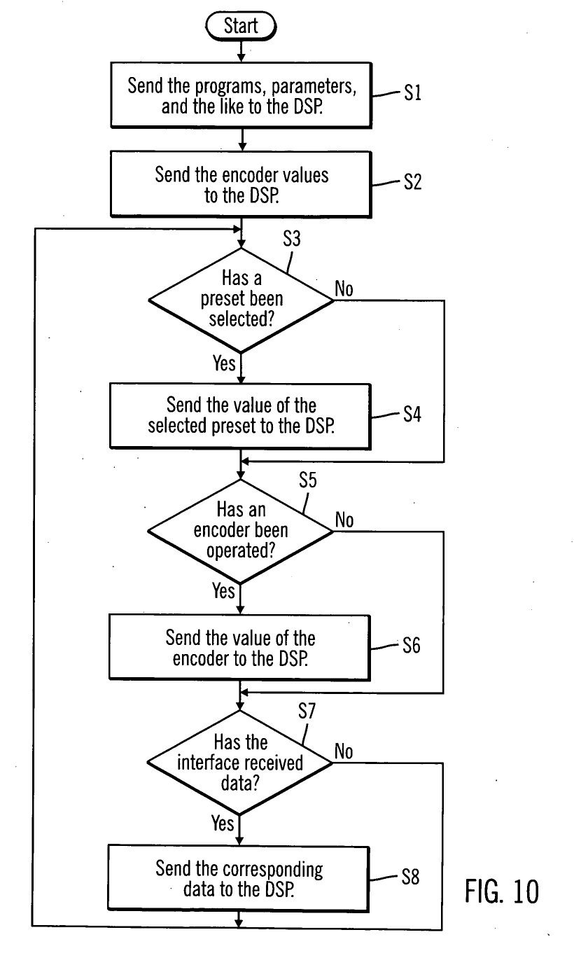

FIG. 10 is a flowchart that shows the processing that is executed by the CPU 10 in accordance with the programs that are stored in the ROM 12.

When the power to this system is turned on, first the effect processing program that is executed by the DSP 22 and the parameters and tables for the preset that has been selected, which are stored in the ROM 12, are sent to the DSP 22 (S1). Next, the values at which the encoders 42, 44, and 46 are set are read out and sent to the DSP 22, and an instruction is given so that the DSP 22 starts the effect processing (S2).

The DSP 22 stores the various types of data that have been sent from the CPU 10 in a specified region of the RAM 22a in the DSP 22 and starts the effect processing in accordance with the program that has been received.

Next, the CPU 10 makes a determination as to whether or not any of the presets has been selected by means of the touch panel 40 of the operating panel 18 (S3), and in those cases where it has been determined that a selection has been made (S3: yes), the processing program, parameters, and tables that correspond to the preset that has been selected are read out from the ROM 12 and sent to the DSP 22 (S4) and the routine advances to the processing of S5. On the other hand, in those cases where it has been determined by the processing of S3 that the selection of a preset is not being carried out (S3: no), the routine advances to the processing of S5.

In the processing of S5 a determination is made as to whether or not any of the encoders 42, 44, and 46 has been operated and, in those cases where it has been determined that an encoder has been operated (S5: yes), the value of the parameter that corresponds to the encoder is calculated and the value is sent to the DSP 22 (S6) and the routine advances to the processing of S7. On the other hand, in those cases where it has been determined in the processing of S5 that none of the encoders has been operated (S5: no), the routine advances to the processing of S7.

In the processing of S7, a determination is made as to whether or not the data that are required for the effect processing by the DSP 22 have been received via the interface 16 and, in those cases where it has been determined that the data required for the effect processing have been received (S7: yes), the values of the parameters that are used by the DSP are calculated in accordance with the data, the values are sent to the DSP 22 (S8), and the routine returns to the processing of S3. On the other hand, in those cases where it has been determined in the processing of S7 that the data required for the effect processing have not been received (S7: no), the routine returns to the processing of S3.

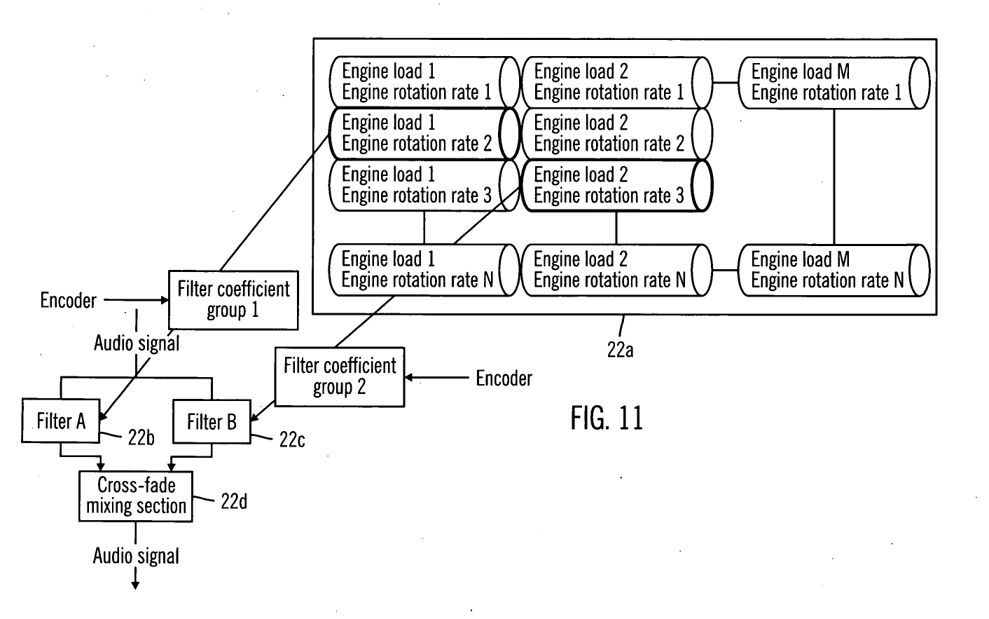

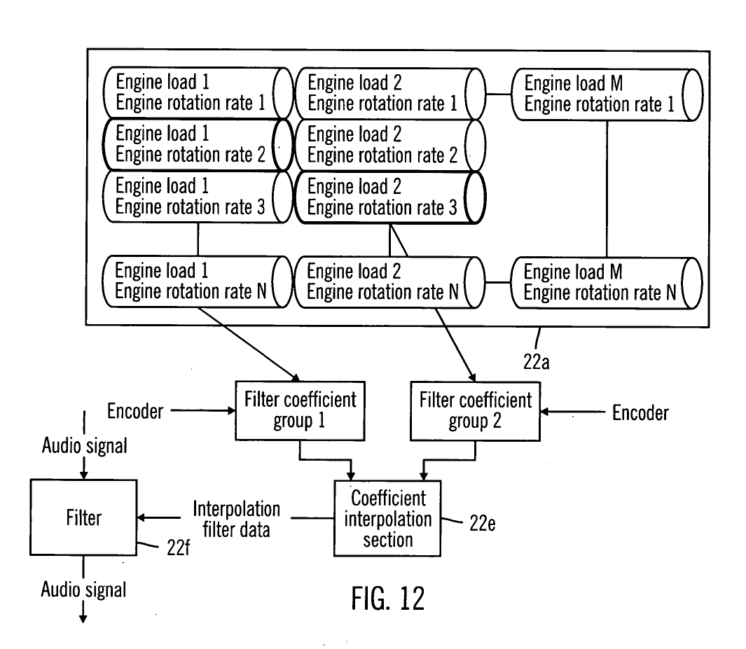

Next, an explanation will be given regarding the processing in the DSP 22. The explanation will be given here regarding two methods: the method that is shown in FIG. 11 and the method that is shown in FIG. 12.

In FIG. 11 and FIG. 12, the cutoff frequency and the gain of the HSHV 50 and the center frequency and the gain and the Q value of the bandpass filter, that correspond to the respective discrete values of the load and the RPM of the engine, are stored as a table in the RAM 22a. This table is stored in the ROM 12 and is transferred in the processing of S1 or S4 of the flowchart that has been described with FIG. 10 by the CPU 10 in conformance with the type of vehicle that has been selected. In addition, the filter A 22b and the filter B 22c that are shown in FIG. 11 and the filter 22f that is shown in FIG. 12 are formed by the DSP 22 and the HSHV 50 and the bandpass filter 52 are arranged in series.

FIG. 11 is a drawing that shows schematically the first method that is executed in the DSP 22 in which the frequency characteristics are changed in conformance with the changes in the load and the RPM of the engine. In FIG. 11, when the load and the RPM of the engine are applied, the filter coefficient groups that comprise the values of the cutoff frequency, the gain, and the Q that are for the two conditions that are close to the values of the load and the RPM are read out from the table that has been stored in the RAM 22a. They are set in conformance with the control values that are set by the racy 42 and the bottom 44, which are the encoders. One filter coefficient group 1 is supplied to the filter A 22a while, at the same time, the other filter coefficient group 2 is supplied to the filter B 22c. The frequency characteristics of the engine sound that has been input are modified respectively by the filter A 22b and the filter B 22c and input to the cross-fade mixing section 22d. The cross-fade mixing section combines and outputs the automobile sound signals that have been input at the mixing ratio that corresponds to the load and the RPM of the engine that have been applied.

By this means, it is possible to change the characteristics of the filter in conformance with the load and the RPM of the engine.

FIG. 12 is a method in which, in contrast to the method where the filters are switched that was explained while referring to FIG. 11, the parameters that applied to a single filter are interpolated. When the load and the RPM of the engine are applied, the filter coefficient group 1 and the filter coefficient group 2 for the two conditions that are close to the values of the load and the RPM are read out from the table that has been stored in the RAM 22a, an interpolation operation is carried out in the coefficient interpolation section 22e, and the coefficients that have been interpolated are supplied to the filter 22f.

Incidentally, the explanation has been given with FIG. 11 and FIG. 12 in which the filter coefficient groups that correspond to the load and the RPM of the engine are stored in a table; however, it may be set up such that a filter coefficient group is derived based on the three parameters of the load, the RPM, and the envelope level, and the frequency characteristics changed using this filter coefficient group.

As has been explained above, in accordance with the automobile sound processing system of this preferred embodiment, the engine sound is changed in conformance with the load or the RPM as well as the level of the engine sound and this change can be accomplished in accordance with the vehicle type and the preferences of the user.

Incidentally, the detection means in which the engine sound of the automobile is detected may be a sensor such as a piezoelectric ceramic that has been attached to the air intake pipe, the exhaust pipe of the engine, the muffler, and the like or a microphone that has been disposed in the engine area.

An explanation was given above of the present invention based on the preferred embodiment described above, however, the present invention is in no way limited to the preferred embodiment described above; and the fact that various modifications and changes are possible that do not deviate from and are within the scope of the essentials of the present invention can be easily surmised.

For example, in the preferred embodiment described above, the parameters of the HSHV have been changed in accordance with the envelope level of the engine sound but instead of the HSHV 50, a resonance attached low pass filter, or high pass filter, or comb filter may be used.

In addition, it has been set up such that the parameters of the HSHV 50 are changed in accordance with the envelope level of the engine sound but instead of the envelope level of the engine sound, this may be done using the engine load, or the engine RPM, or a combination of these. This would also be the same for the bandpass filter 52.

In addition, in the preferred embodiment described above, it has been set up such that the frequency characteristics of the automobile sound that is input are changed by means of a filter, but an effect such as distortion in which the automobile sound is distorted and the like may also be applied. In those cases where a distortion effect is applied, it may be set up such that the depth of the distortion is changed in conformance with the load of the engine.

1. An automobile sound processing system comprising:
a detection means with which the automobile sound that is generated by the motive power section of the automobile is detected;
an input means with which the automobile sound that has been detected by the detection means is input; and
an effect imparting means with which an effect is imparted to the automobile sound that is input in the input means in conformance with the operating state of the motive power section of the automobile.

2. The automobile sound processing system of claim 1, wherein the effect imparting means is one in which the frequency characteristics of the automobile sound that is input in the input means are changed.

3. The automobile sound processing system of claim 1, wherein the effect imparting means is one in which the characteristics of a filter through which the automobile sound is passed are changed in conformance with the level of the automobile sound that is input in the input means.

4. The automobile sound processing system of claim 2, wherein the effect imparting means is one in which the characteristics of a filter through which the automobile sound is passed are changed in conformance with the level of the automobile sound that is input in the input means.

5. The automobile sound processing system of claim 1, wherein the effect imparting means is one in which the characteristics of a filter through which the automobile sound that is input in the input means is passed are changed in conformance with the RPM of the engine of the automobile.

6. The automobile sound processing system of claim 2, wherein the effect imparting means is one in which the characteristics of a filter through which the automobile sound that is input in the input means is passed are changed in conformance with the RPM of the engine of the automobile.

7. The automobile sound processing system of claim 1, wherein the effect imparting means is one in which the characteristics of a filter through which the automobile sound that is input in the input means is passed are changed in conformance with the automobile engine load.

8. The automobile sound processing system of claim 2, wherein the effect imparting means is one in which the characteristics of a filter through which the automobile sound that is input in the input means is passed are changed in conformance with the automobile engine load.

9. The automobile sound processing system of claim 1, further comprising:
a vehicle type selection means;
wherein the effect imparting means is one in which the conditions of the effect that is imparted to the automobile sound are further changed in conformance with a vehicle type that has been selected by the vehicle type selection means.

10. The automobile sound processing system of claim 2, further comprising:
a vehicle type selection means;
wherein the effect imparting means is one in which the conditions of the effect that is imparted to the automobile sound are further changed in conformance with a vehicle type that has been selected by the vehicle type selection means.

11. The automobile sound processing system of claim 1, further comprising:
an operator for setting a control value;
wherein the effect imparting means is one in which the conditions of the effect that is imparted to the automobile sound are further changed in conformance with the control value that has been set by the operator.

12. The automobile sound processing system of claim 2, further comprising:
an operator for setting a control value;
wherein the effect imparting means is one in which the conditions of the effect that is imparted to the automobile sound are further changed in conformance with the control value that has been set by the operator.

13. The automobile sound processing system of claim 1, wherein the effect imparting means is configured by means of a DSP.

14. The automobile sound processing system of claim 2, wherein the effect imparting means is configured by means of a DSP.

15. The automobile sound processing system of claim 9, wherein the vehicle type selection means is one that is configured by means of a touch panel, and by pointing at a touch position of the plurality of display positions for automobile types that are displayed on the touch panel, the vehicle type that is displayed at that position is selected.

16. The automobile sound processing system of claim 10, wherein the vehicle type selection means is one that is configured by means of a touch panel, and by pointing at a touch position of the plurality of display positions for automobile types that are displayed on the touch panel, the vehicle type that is displayed at that position is selected.

17. The automobile sound processing system of claim 11, wherein the proportion of the change in the gain of a filter that corresponds to the RPM of the engine of the automobile is controlled in conformance with a control value that is set by means of the operator.

18. The automobile sound processing system of claim 12, wherein the proportion of the change in the gain of a filter that corresponds to the RPM of the engine of the automobile is controlled in conformance with a control value that is set by means of the operator.

19. The automobile sound processing system of claim 11, wherein:
the effect imparting means is a bandpass filter through which the automobile sound that is input in the input means is passed; and
the proportion of the change in the center frequency of the bandpass filter that corresponds to the RPM of the engine of the automobile is controlled in conformance with a control value that is set by means of the operator.

20. The automobile sound processing system of claim 12, wherein:
the effect imparting means is a bandpass filter through which the automobile sound that is input in the input means is passed; and
the proportion of the change in the center frequency of the bandpass filter that corresponds to the RPM of the engine of the automobile is controlled in conformance with a control value that is set by means of the operator.

21. The automobile sound processing system of claim 11, wherein:
the effect imparting means is a shelving filter through which the automobile sound that is input in the input means is passed; and
the proportion of the change in the gain of the shelving filter that corresponds to the envelope level of the automobile sound is controlled in conformance with a control value that is set by means of the operator.

22. The automobile sound processing system of claim 12, wherein:
the effect imparting means is a shelving filter through which the automobile sound that is input in the input means is passed; and
the proportion of the change in the gain of the shelving filter that corresponds to the envelope level of the automobile sound is controlled in conformance with a control value that is set by means of the operator.

23. An automobile sound processing system for processing an automobile sound signal that is detected from an automobile having an operating state, the system comprising:
an effect imparter that produces a resulting audio signal by imparting an effect to the detected automobile sound signal based on the operating state of the automobile.

24. The system of claim 23, wherein the effect that is imparted by the effect imparter is to change the frequency characteristics of the detected automobile sound signal based on the operating state of the automobile.

25. The system of claim 23, wherein the effect that is imparted by the effect imparter is to change the volume of the detected automobile sound signal based on the operating state of the automobile.

26. The system of claim 23, wherein the effect that is imparted by the effect imparter is to change the tone of the detected automobile sound signal based on the operating state of the automobile.

27. The system of claim 23, wherein the effect imparter comprises a bandpass filter.

28. The system of claim 27, wherein the effect that is imparted to the detected automobile sound signal is imparted by the bandpass filter and the center frequency of the bandpass filter changes based on the operating state of the automobile.

29. The system of claim 27, wherein the effect that is imparted to the detected automobile sound signal is imparted by the bandpass filter and the gain of the bandpass filter changes based on the operating state of the automobile.

30. The system of claim 27, wherein the effect that is imparted to the detected automobile sound signal is imparted by the bandpass filter and the Q of the bandpass filter changes based on the operating state of the automobile.

31. The system of claim 23, wherein the effect imparter comprises a high shelving filter.

32. The system of claim 31, wherein the effect that is imparted to the detected automobile sound signal is imparted by the high shelving filter and the cutoff frequency of the high shelving filter changes based on the operating state of the automobile.

33. The system of claim 31, wherein the effect that is imparted to the detected automobile sound signal is imparted by the high shelving filter and the gain of the high shelving filter changes based on the operating state of the automobile.

34. The system of claim 23, wherein the effect that is imparted to the detected automobile sound signal by the effect imparter is further based on a user selected vehicle type.

35. The system of claim 23, wherein the effect that is imparted to the detected automobile sound signal by the effect imparter is further based on a user selected control value.

36. The system of claim 23, wherein the operating state of the automobile is determined from the RPM of an engine of the automobile.

37. The system of claim 23, wherein the operating state of the automobile is determined from the engine load of the automobile.

38. The system of claim 23, wherein the operating state of the automobile is determined from an envelope level of an engine sound of the automobile.

39. The system of claim 23, wherein the automobile sound is detected by a sensor.

40. The system of claim 23, further comprising:
a sound generator that generates a sound from the resulting audio signal.

41. The system of claim 40, wherein the sound generator comprises a speaker.

42. A method for processing an automobile sound signal that is detected from an automobile having an operating state, the method comprising:
producing a resulting audio signal by imparting an effect to the detected automobile sound signal based on the operating state of the automobile.

43. The method of claim 42, wherein the step of producing a resulting audio signal by imparting an effect to the detected automobile sound signal based on the operating state of the automobile, comprises:
producing a resulting audio signal by changing the frequency characteristics of the detected automobile sound signal based on the operating state of the automobile.

44. The method of claim 42, wherein the step of producing a resulting audio signal by imparting an effect to the detected automobile sound signal based on the operating state of the automobile, comprises:
producing a resulting audio signal by changing the volume of the detected automobile sound signal based on the operating state of the automobile.

45. The method of claim 42, wherein the step of producing a resulting audio signal by imparting an effect to the detected automobile sound signal based on the operating state of the automobile, comprises:
producing a resulting audio signal by changing the tone of the detected automobile sound signal based on the operating state of the automobile.

46. The method of claim 42, wherein the step of producing a resulting audio signal by imparting an effect to the detected automobile sound signal based on the operating state of the automobile, comprises:
producing a resulting audio signal by passing the detected automobile sound signal through a filter and changing the filter characteristics of the filter based on the operating state of the automobile.

47. The method of claim 42, wherein the step of producing a resulting audio signal by imparting an effect to the detected automobile sound signal based on the operating state of the automobile, comprises:
producing a resulting audio signal by passing the detected automobile sound signal through a bandpass filter and changing the center frequency of the bandpass filter based on the operating state of the automobile.

48. The method of claim 42, wherein the step of producing a resulting audio signal by imparting an effect to the detected automobile sound signal based on the operating state of the automobile, comprises:
producing a resulting audio signal by passing the detected automobile sound signal through a bandpass filter and changing the gain of the bandpass filter based on the operating state of the automobile.

49. The method of claim 42, wherein the step of producing a resulting audio signal by imparting an effect to the detected automobile sound signal based on the operating state of the automobile, comprises:
producing a resulting audio signal by passing the detected automobile sound signal through a high shelving filter and changing the cutoff frequency of the high shelving filter based on the operating state of the automobile.

50. The method of claim 42, wherein the step of producing a resulting audio signal by imparting an effect to the detected automobile sound signal based on the operating state of the automobile, comprises:
producing a resulting audio signal by passing the detected automobile sound signal through a high shelving filter and changing the gain of the high shelving filter based on the operating state of the automobile.

51. The method of claim 42, wherein the step of producing a resulting audio signal by imparting an effect to the detected automobile sound signal based on the operating state of the automobile, comprises:
producing a resulting audio signal by imparting an effect to the detected automobile sound signal based on the RPM of an engine of the automobile.

52. The method of claim 42, wherein the step of producing a resulting audio signal by imparting an effect to the detected automobile sound signal based on the operating state of the automobile, comprises:
producing a resulting audio signal by imparting an effect to the detected automobile sound signal based on the engine load of the automobile.

53. The method of claim 42, wherein the step of producing a resulting audio signal by imparting an effect to the detected automobile sound signal based on the operating state of the automobile, comprises:
producing a resulting audio signal by imparting an effect to the detected automobile sound signal based on an envelope level of an engine sound of the automobile.

54. The method of claim 42, wherein the step of producing a resulting audio signal by imparting an effect to the detected automobile sound signal based on the operating state of the automobile, comprises:
producing a resulting audio signal by imparting an effect to the detected automobile sound signal based on the operating state of the automobile and further based on a vehicle type that has been selected.

55. The method of claim 42, wherein the step of producing a resulting audio signal by imparting an effect to the detected automobile sound signal based on the operating state of the automobile, comprises:
producing a resulting audio signal by imparting an effect to the detected automobile sound signal based on the operating state of the automobile and further based on a control value that has been set.

56. The method of claim 42, further comprising:
generating a sound using the resulting audio signal.
